(19) United States
(12) Patent Application Publication
(10) Pub. No.: US 2025/0214159 A1
(43) Pub. Date: Jul. 3, 2025

(54) A REINFORCED TOOL ARM FOR A POWER CUTTER

(71) Applicant: HUSQVARNA AB, Huskvarna (SE)

(72) Inventors: Par CARLSSON, Hyssna (SE); Torbjorn ALMQVIST, Goteborg (SE)

(21) Appl. No.: 18/853,405

(22) PCT Filed: Mar. 20, 2023
(86) PCT No.: PCT/SE2023/050237

§ 371 Date: Oct. 1, 2024

(30) Foreign Application Priority Data
Apr. 4, 2022 (SE) 2250424-5

(51) Int. Cl. B23D 45/16; B23D 47/12; B28D 1/04

(52) U.S. Cl. CPC B23D 45/16; B23D 47/12; B28D 1/045

(57) ABSTRACT

A tool arm (130) for a power cutter (100), the tool arm comprising a metal component (131) and a non-metal component (132) arranged to support and to enclose a drive mechanism, the drive mechanism comprising a first drive pulley, a second drive pulley, and a belt arranged to be driven by the first drive pulley and arranged to drive the second drive pulley, wherein respective axes of rotation of the first and second drive pulleys are normal to a plane dividing the tool arm (130) in first and second parts, wherein a centre of the drive belt, when installed, lies in the plane, the metal component (131) comprises a first reinforcement structure (240) extending in an extension direction normal to the plane from the first part, past the plane, and into the second part.

### TECHNICAL FIELD

The present disclosure relates to hand-operated construction equipment. There are disclosed improved tool arms for power cutters which provide increased mechanical strength and rigidity to the power cutter assembly.

### BACKGROUND

Power cutters are hand-held power tools with rotatable cutting discs arranged for abrasive operation. A power cutter can be used with advantage to cut hard materials such as concrete and stone. Cutting discs suitable for cutting into metal work objects are also available.

The quality of the cut depends at least to some extent on the selection of a suitable cutting disc for the cutting task, and on the machine used to perform the cut. It is, for instance, important that the tool arm which connects the rotatable cutting disc to the motor used to drive the disc is sufficiently rigid so that it does not bend or twist as the cutting disc enters into the work object, since this will have a negative effect on the quality of the cut.

At the same time, it is important that the weight and/or size of the power cutter does not become prohibitively large. Weight and size are particularly important for smaller battery-powered power cutters, such as power cutters with 10-inch diameter cutting discs.

It is also important that the tool arm is able to withstand the harsh environments in which a power cutter is normally used. The tool arm should, preferably, be durable enough to withstand strong vibration, mechanical stress and also impacts from hard objects.

There is a need for lightweight yet rigid and durable tool arms for use with power cutters.

### SUMMARY

It is an objective of the present disclosure to provide improved power cutters with rigid tool arms that are compact and has low weight. This objective is obtained by a tool arm for a power cutter. The tool arm comprises a metal component and a non-metal component arranged to both support and enclose a drive mechanism. The drive mechanism comprises a first drive pulley, a second drive pulley, and a belt arranged to be driven by the first drive pulley and arranged to drive the second drive pulley. Respective axes of rotation of the first and second drive pulleys are normal to a plane dividing the tool arm into first and second parts. A centre of the drive belt, when installed, lies in this plane. A main part of the metal component preferably lies in the first part and a main part of the non-metal component preferably lies in the second part. A portion of the metal component is formed as a first reinforcement structure that extends in an extension direction which is normal to the plane, from the first part, past the plane, and into the second part, i.e., past the drive belt when the drive belt is installed.

The first reinforcement structure provides an increased resilience to both bending and torsion of the tool arm, which is an advantage. The increase in mechanical strength is achieved without significant increase in size and weight of the tool arm. The first reinforcement structure also increases the ability of the tool arm to withstand impact, which is an advantage.

The metal component, which may be formed, e.g., in magnesium, aluminum or steel, can be integrally formed with the first reinforcement structure, i.e., machined or molded in a single piece of metal.

The first reinforcement structure optionally has first and second side surfaces extending in the general direction on the plane, where the first side surface is separated from the second side surface by the plane. The two side surfaces can form part of the external surface or hull of the tool arm, which means that the first reinforcement structure also increases the integrity of the external hull of the tool arm, making it more robust against impact from objects in the environment in which the power cutter is being used. The tool arm may for instance have a first outer side surface and a second outer side surface extending longitudinally with respect to the tool arm and parallel to the plane, and a rim portion which connects the first outer side surface to the second outer side surface. The first reinforcement structure advantageously forms part of the rim portion to increase the strength of the rim portion.

In case the part of the rim portion formed by the first reinforcement structure is arranged to face a front handle of the power cutter, i.e., facing upwards, then the first reinforcement structure protects the tool arm from mechanical impact by objects falling down onto the tool arm from above, which is an advantage.

The first reinforcement structure is preferably formed as a hollow structure arranged to enclose an internal volume. This “box-like” structure has high mechanical strength and also a low weight compared to a solid metal reinforcement member. The hollow structure can also be divided by one or more ribs to form at least two internal volumes of the tool arm. These ribs further increase the mechanical strength of the tool arm, and also the ability to resist torsion, which is an advantage.

The tool arm optionally comprises a second reinforcement structure extending along a line from a rotation center of the first drive pulley to a rotation center of the second drive pulley. A dimension of the second reinforcement structure in direction normal to the plane gradually increases towards the rotation center of the first drive pulley. This second reinforcement structure primarily resists bending of the tool arm. It is an advantage that the largest dimension is close to the first drive pulley where the bending forces are highest during use. It is a further advantage that the dimension of the second reinforcement member is smallest close to the second drive pulley, since this makes room for the second drive pulley which normally has a larger diameter compared to the first drive pulley.

The metal component may furthermore comprise integrally formed bolt holes and a supporting surface for attaching an electric motor to the tool arm. This integration of the tool arm and electric motor is effective in terms of size, and also provides a stable mechanical connection between motor, first drive pulley, and tool arm, which is an advantage.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated. Further features of, and advantages with, the present invention will become apparent when studying the appended claims and the following description. The skilled person realizes that different features of the present invention may be combined to create embodiments other than those described in the following, without departing from the scope of the present invention.

### BRIEF DESCRIPTION OF THE DRAWINGS

The present disclosure will now be described in more detail with reference to the appended drawings, where

FIG. 1 shows an example power cutter;

FIGS. 2A-B schematically illustrate a tool arm for a power cutter;

FIGS. 3A-B show side views of an example tool arm;

FIG. 4A schematically illustrates a tool arm; and

FIG. 4B is an exploded view of a tool arm on a power cutter.

### DETAILED DESCRIPTION

The invention will now be described more fully hereinafter with reference to the accompanying drawings, in which certain aspects of the invention are shown. This invention may, however, be embodied in many different forms and should not be construed as limited to the embodiments and aspects set forth herein; rather, these embodiments are provided by way of example so that this disclosure will be thorough and complete, and will fully convey the scope of the invention to those skilled in the art. Like numbers refer to like elements throughout the description.

It is to be understood that the present invention is not limited to the embodiments described herein and illustrated in the drawings; rather, the skilled person will recognize that many changes and modifications may be made within the scope of the appended claims.

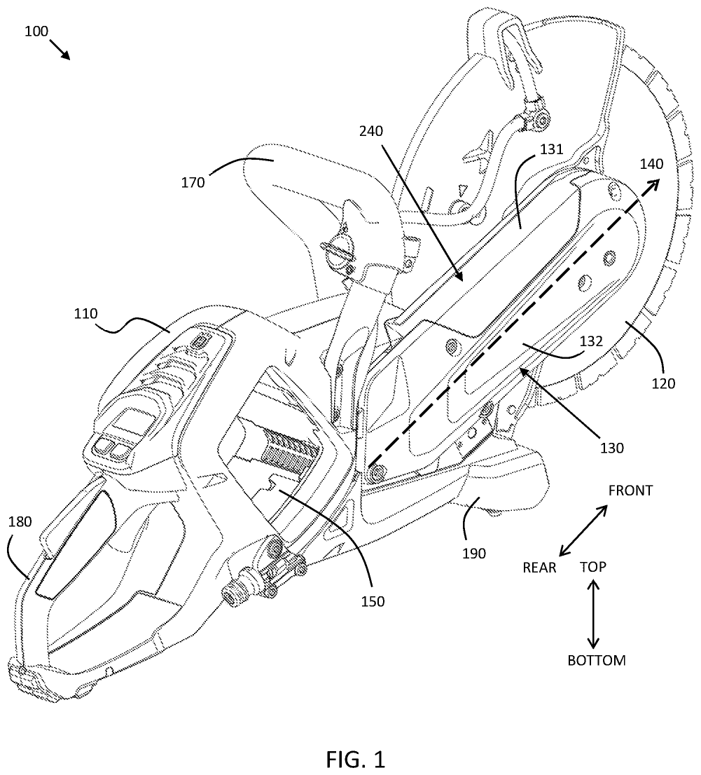

FIG. 1 shows a power cutter 100, i.e., a hand-held work tool for cutting into hard materials such as concrete and stone. The work tool comprises a main body 110 with a motor (not shown in FIG. 1) connected to a rotatable circular cutting tool 120 via a power cutter tool arm 130. The tool arm 130 extends along a longitudinal extension direction 140 from a rotation center of the motor axle to a rotation center of the tool 120. The power cutter 100 comprises a front handle 170, a rear handle 180, and a ground support member 190. The front handle 170 is arranged distanced from the ground when the power cutter is in resting position supported by the ground support member 190. The rear handle 180 is arranged on the opposite end of the power cutter compared to the rotatable circular cutting tool 120, i.e., distal from the cutting tool 120.

The relative positions of components of the power cutter 100 as well as the different parts of the tool arm 130 can be described in terms of a top, bottom, rear and front direction as indicated in FIG. 1.

This particular example power cutter 100 is an electrically powered work tool arranged to receive an electrical energy source, such as a battery, in a compartment 150. However, the components and techniques discussed herein are also applicable to combustion engine powered work tools and electrical tools powered via cable from electrical mains.

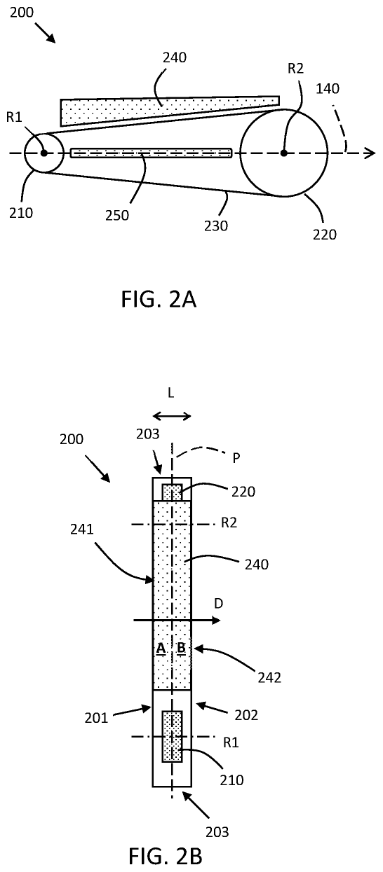

FIGS. 2A and 2B schematically illustrates a drive mechanism 200 both supported by and enclosed by the tool arm 130. The drive mechanism 200 comprises a first drive pulley 210, a second drive pulley 220, and a belt 230 arranged to be driven by the first drive pulley 210 and arranged to drive the second drive pulley 220. The first drive pulley 210 is typically driven by the motor of the power cutter, i.e., the pulley 210 is attached to the motor axle, while the second drive pulley 220 drives the cutting tool 120, directly or via some form of geared transmission. A line drawn between the rotation centers of the first and second drive pulleys may coincide with the longitudinal extension direction 140, but some deviation is of course also possible.

To be supported by can for instance mean that the tool arm 130 comprises a bearing arranged to rotatably support e.g., an axle fixedly attached to a drive pulley. To be supported by can also mean that the tool arm comprises attachment means, such as bolt holes and a supporting surface for holding, e.g., a motor or other component in fixed relation relative to the tool arm 130.

A problem with many power cutters is that the tool arm 130 is not of sufficient mechanical rigidity for ensuring straight and even cuts, i.e., the tool arm is not strong enough to resist bending and torsion during the cutting operation, which results in an uneven cut. It is desired to increase the mechanical rigidity and overall strength of the tool arm 130, but since the weight of the power cutter 100 is also an issue, it is desired to provide a tool arm 130 which does not add significantly to the total weight of the power cutter 100. The size of the power cutter may also be an issue, in particular if a smaller-sized battery-powered tool is desired.

Power cutters are regularly used in harsh environments where they are subject to mechanical impact from various objects in the environment. Plastic is a cost effective body material, but it is not able to withstand impact very well. It is desired to provide reinforcements of the body material of the tool arm at particularly exposed areas. One such area is the upper part of the tool arm, which is close to the tool 120 and which may be subject to impact from objects falling from above.

The tool arms discussed herein comprise a metal component 131 and a non-metal component 132, such as a plastic cover, arranged in combination to support and also to enclose a drive mechanism such as the drive mechanism 200. The drive mechanism is thereby held securely in relation to the power cutter body and also protected from dust and slurry due to being enclosed by the tool arm. The metal component may, e.g., be formed in magnesium, aluminum, or steel, or in a combination of two or more metal materials. Magnesium is preferred over aluminum due to the increased strength, and also preferred over steel due to the smaller weight. The non-metal component is preferably formed in a plastic material.

To improve the mechanical strength of the tool arm, a first reinforcement structure 240 has been arranged along the longitudinal extension direction 140 of the tool arm. This first reinforcement structure has dual purposes. First of all, it reinforces the tool arm to make it more rigid, i.e., better able to resist bending forces and torsion. Second, it forms part of the outer hull of the tool arm, which increases the integrity of the enclosure, making it able to better withstand impact.

FIGS. 2A and 2B schematically illustrate the first reinforcement structure 240 in relation to the drive mechanism 200 of the power cutter. The first drive pulley 210 has a first axis of rotation R1 about which it turns during operation of the cutting tool 120. A drive belt 230 connects the first drive pulley 210 to a second drive pulley 220, which is arranged to rotate about a respective axis of rotation R2. The axes of rotation R1, R2 of the first and second drive pulleys 210, 220 are normal to a plane P (shown in FIG. 2B) which divides the tool arm 130 in first and second parts A, B. A centre of the drive belt 230, when installed, lies in the plane P.

The first reinforcement structure 240 extends in an extension direction D normal to the plane P from the first part A, past the plane P, and into the second part B. In other words, when seen from the top as in FIG. 2B, the first reinforcement member 240 extends normal to the plane to cover the drive belt 230. This extension normal to the plane is also transversal to the longitudinal extension direction 140 of the tool arm 130, which means that the first reinforcement structure 240 is positioned to increase mechanical strength of the tool arm.

The example first reinforcement structure 240 illustrated in, e.g., FIG. 2B, has first and second opposing side surfaces 241, 242 extending along the plane P, or even parallel to the plane P. The first side surface 241 is separated from the second side surface 242 by the plane P and the side surfaces 241, 242 form part of the outer hull of the tool arm.

According to some aspects, the first reinforcement structure 240 has a total extension length L in the extension direction D normal to the plane P. At least 25% of the total extension length L preferably lies in the second part B of the tool arm 130. In FIG. 2B, 50% of the first reinforcement structure 240 lies in the first part A and 50% lies in the second part B. However, this relation can vary between different designs.

A width of the first elongated reinforcement structure 240 measured normal to the plane may be on the order of 20-80 mm, and preferably about 50 mm. A material thickness of the tool arm is preferably at least 1.5 mm, such as above 1.8 mm or about 2 mm.

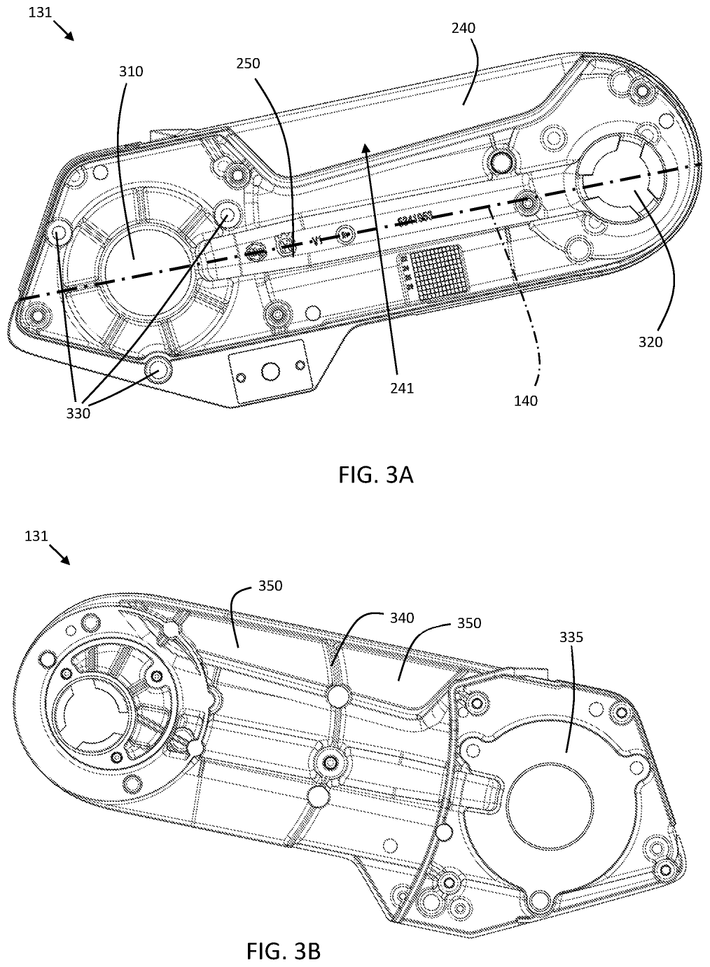

FIGS. 3A and 3B illustrate an example tool arm metal component 131, where the metal component 131 and its first reinforcement structure 240 are integrally formed, i.e., machined or molded, in the same piece of metal. The first reinforcement structure 240 is advantageously formed as a hollow structure, with side walls enclosing an internal volume of the first reinforcement structure. This reduces the weight of the first reinforcement structure considerably, which is an advantage. The hollow structure of the first reinforcement structure 240 can furthermore be divided by one or more ribs 340 forming at least two internal volumes 350 of the tool arm. The ribs provide additional mechanical strength to the first reinforcement structure 240 and therefore also to the tool arm 130.

The tool arm 130 optionally also comprises a second reinforcement structure 250 extending along a line from a rotation center of the first drive pulley 210 to a rotation center of the second drive pulley 220, as schematically illustrated in FIG. 2A. A dimension of the second reinforcement structure 250 in direction normal to the plane P gradually increases towards the rotation center of the first drive pulley 210. This gradual increase in dimension increases the strength of the tool arm close to the first drive pulley 210 where bending forces are more pronounced. Also, the smaller dimension normal to the plane P close to the second drive pulley 220 means that there is more room for the larger second drive pulley 220 inside the tool arm.

The metal component 131 optionally comprises integrally formed bolt holes 330 and a supporting surface 335 for attaching an electric motor to the tool arm 130, as shown in FIG. 3A and in FIG. 3B. This allows an electric motor to be secured directly to the tool arm 130, which is an advantage since it conserves space and also increases the mechanical strength of the assembly.

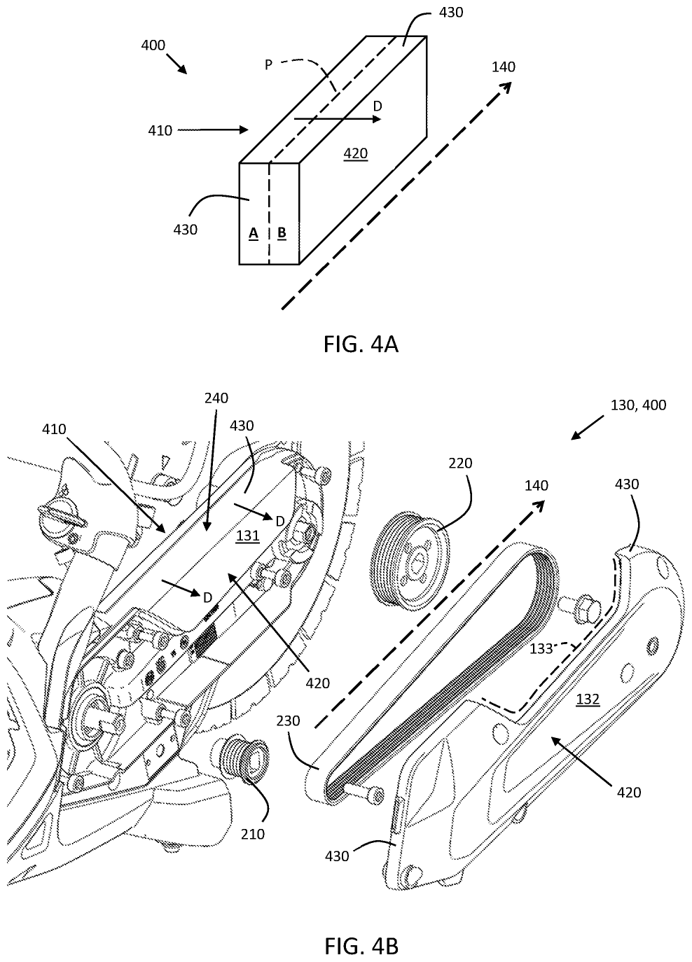

With reference to FIG. 4A and FIG. 4B, the tool arm 130 is essentially an elongated box structure 400 with a first outer side surface 410 and a second outer side surface 420 that extend in the longitudinal extension direction 140 of the tool arm 130, essentially normal to the plane P illustrated by dashed lines in FIG. 4A. The plane P divides the tool arm into first and second parts A, B as discussed above and illustrated in FIG. 2B. The first part A and the second part B are also indicated in FIG. 4A. The side surfaces are also at least almost parallel to the plane P, i.e., some small angle on the order of a few degrees may be present between the side surfaces and the plane P. A rim portion 430 connects the first outer side surface 410 to the second outer side surface 420. The first reinforcement structure 240 advantageously forms part of this rim portion 430. This means that the first reinforcement structure protects the tool arm against mechanical impact, which is an advantage. The part of the rim portion 430 formed by the first reinforcement structure 240 is preferably arranged to face a front handle 170 of the power cutter 100, i.e., facing away from the ground support member 190. This means that objects falling down onto the tool arm from above, during use, hits the first reinforcement structure 240 and not the non-metal component 132 which may be weaker and less able to withstand impact from hard objects. The first reinforcement structure 240 may furthermore form part of the first outer side surface 410 and part of the second outer side surface 420.

As discussed above, the tool arms 130 discussed herein, not just that illustrated in FIG. 4B, comprises a metal component 131 and a non-metal component 132 arranged to support and to enclose the drive mechanism, which comprises a first drive pulley 210, a second drive pulley 220, and a belt 230 arranged to be driven by the first drive pulley 210 and to drive the second drive pulley 220. The plane P (not shown in FIG. 4B) divides the tool arm 130 into the first and second parts A, B. The centre of the drive belt 230, when installed, lies in the plane P. The metal component 131 comprises a first reinforcement structure 240 that extends in an extension direction D that is normal to the plane P. The metal component 131 extends from the first part A, past the plane P (i.e., past the drive belt 230 when it is installed), and into the second part B. A cut-out section 133 matching the first reinforcement structure form has been removed from the non-metal component 132 such that the metal component and the non-metal component are able to mate snugly around a part of the first reinforcement structure 240. This way the first reinforcement structure 240 strengthens the mechanical bond between the first part and the second part, due at least in part to the overlap across the drive belt 230. A main part of the metal component 131 lies in the first part A and a main part of the non-metal component 132 lies in the second part B. This means that the largest part (in terms of both volume and weight) of the metal component 131 lies in the first part A, while the largest part (in terms of both volume and weight) of the non-metal component 132 lies in the second part B. In most example implementations the entirety of the non-metal component 132 lies in the second part B while the metal component 131 extends from the first part A and into the second part B, i.e., across the drive belt 230 when it is installed. This is perhaps best seen in FIG. 1, where the parts of FIG. 4B are shown when assembled.

1. A tool arm for a power cutter, the tool arm comprising a metal component and a non-metal component arranged to support and to enclose a drive mechanism,
the drive mechanism comprising a first drive pulley, a second drive pulley, and a belt arranged to be driven by the first drive pulley and arranged to drive the second drive pulley,
wherein respective axes of rotation of the first and second drive pulleys are normal to a plane dividing the tool arm into a first part and a second parts, wherein a center of the drive belt, when installed, lies in the plane, and
wherein the metal component comprises a first reinforcement structure extending in an extension direction normal to the plane from the first part, past the plane, and into the second part.

2. The tool arm according to claim 1, wherein the first reinforcement structure has first and second side surfaces extending along the plane, wherein the first side surface is separated from the second side surface by the plane.

3. The tool arm according to claim 1, wherein the first reinforcement structure has a total extension length in the extension direction normal to the plane, wherein at least 25% of the total extension length lies in the second part of the tool arm.

4. The tool arm according to claim 1, having a first outer side surface and a second outer side surface extending longitudinally with respect to the tool arm and parallel to the plane, wherein a rim portion connects the first outer side surface to the second outer side surface, wherein the first reinforcement structure forms part of the rim portion.

5. The tool arm according to claim 4, wherein the part of the rim portion formed by the first reinforcement structure is arranged to face a front handle of the power cutter.

6. The tool arm according to claim 4, wherein the first reinforcement structure forms part of the first outer side surface and part of the second outer side surface.

7. The tool arm according to claim 1, wherein the metal component comprises any of magnesium, aluminum, and steel.

8. The tool arm according to claim 1, wherein the metal component and the first reinforcement structure are integrally formed.

9. The tool arm according to claim 1, wherein the first reinforcement structure is a hollow structure.

10. The tool arm according to claim 9, wherein the hollow structure of the first reinforcement structure is divided by one or more ribs forming at least two internal volumes of the tool arm.

11. The tool arm according to claim 1, comprising a second reinforcement structure extending along a line from a rotation center of the first drive pulley to a rotation center of the second drive pulley, wherein a dimension of the second reinforcement structure in direction normal to the plane gradually increases towards the rotation center of the first drive pulley.

12. The tool arm according to claim 1, wherein a width of the first elongated reinforcement structure measured normal to the plane is between 20-80 mm.

13. The tool arm according to any previous claim 1, wherein a material thickness of the tool arm is at least 1.5 mm.

14. The tool arm according to claim 1, wherein the non-metal component is formed by a plastic cover.

15. The tool arm according to claim 1, wherein the metal component comprises integrally formed bolt holes and a supporting surface for attaching an electric motor to the tool arm.

16. A power cutter comprising the tool arm according to claim 1.
